(19) United States
(12) Patent Application Publication
(10) Pub. No.: US 2005/0125551 A1
(43) Pub. Date: Jun. 9, 2005

(54) High-speed pattern storing and matching method

(76) Inventors: Jin-Tae Oh, Daejeon-city (KR); Young-Joon Heo, Youngcheon-city (KR); Jong-Soo Jang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,262

(22) Filed: Dec. 31, 2003

(30) Foreign Application Priority Data
Dec. 5, 2003 (KR) 10-2003-0087885

(51) Int. Cl. G06F 11/30

(52) U.S. Cl. 709/230; 713/201

(57) ABSTRACT

The high-speed pattern storing and matching method includes dividing pattern data having a defined rule into parts having a defined length, tabulating and storing input position sequence information of the divided parts of the pattern data and information about the pattern data subsequent to the corresponding divided part of the pattern data, dividing input pattern data into parts having a defined length, independently searching the divided parts of the input pattern data, and determining whether the pattern data input according to each input position sequence are matched to the pattern data having the defined rules, thereby enabling high-speed pattern matching in real time and storing repeating words in one address of memories to enhance the memory efficiency.

### CROSS REFERENCE TO RELATED APPLICATION

This application claims priority to and the benefit of Korea Patent Application No. 2003-87885 filed on Dec. 5, 2003 in the Korean Intellectual Property Office, the content of which is incorporated herein by reference.

### BACKGROUND OF THE INVENTION

(a) Field of the Invention

The present invention relates to a high-speed pattern storing and matching method. More specifically, the present invention relates to a high-speed storing and matching method that provides a high-speed pattern matching device implemented in hardware to be used in a lookup device for a specific pattern in a database, such as an intrusion detection system.

(b) Description of the Related Art

With the use of networks being popularized, there is a need for a device for protecting against network intrusions that do not merely attack several servers as in the past, but that make whole networks powerless and interrupt network services.

The conventional network-based intrusion detection technique is disclosed in Korean Patent Publication No. 10-2001-0012532 under the title of “Network-Based Intrusion Detection System”, which proposes a network intrusion detection engine using high-speed hardware and pattern matching hardware to implement network-based intrusion detection on a high-speed network.

This technique is, however, problematic in that accurate interface processing speed and hardware components for high-speed intrusion detection are not specified.

Many methods for network intrusion detection have been developed so far, and particularly a rule-based packet matching method is most effectively used, and a hash method for search of sentences or words is used in many databases.

FIG. 1 is a block diagram of a structure for a conventional pattern searching method.

Referring to FIG. 1, the pattern searching structure comprises a controller 110, a plurality of rules 1 to n 120 to 140, an OR gate 150, an output 160, and a register 170.

The controller 110 controls the individual rules 1 to n 120 to 140, each of which applies a control signal to cause a MAC matcher 121, a protocol section 122, an IP address section 123, and a port number section 124 to process four internal packet heads to compare MAC address, protocol, IP address, and port number with information of normal packets, and controlling a contents pattern matcher 126 to output a signal representing that the internal packets are all normal when the AND gate 125 outputs a signal representing that the MAC matcher 125, the protocol section 122, the IP address section 123, and the port number section 124 are all normal, according to the comparison result.

The packet output 160 outputs an error signal when the OR gate 150 performs an OR operation of the signals from the contents pattern matcher 126 of the rules 1 to n 120 to 140 and outputs an abnormal packet signal from at least one of the rules 1 to n 120 to 140. Otherwise, the packet output 160 outputs the corresponding packet when all the rules 1 to n 120 to 140 send a normal packet signal.

The rules 1 to n 120 to 140 comprise a program in an FPGA (Field Programmable Gate Array) chip, which program is variable depending on the number of the rules.

The packet searching process can be described in further detail as follows.

FIG. 2 is a detailed diagram of a structure for the conventional pattern searching method.

Referring to FIG. 2, the contents pattern matcher 126 for searching the pattern of input strings of the 32-bit register 127 receives, for example, a string of “patterns” on the data input in the unit of 32 bits for 3 clocks. Here, the 32-bit data contains a string “pat” in Cyc (Cycle) 1, a string “tern” in Cyc 2, and a string “s” in Cyc 3.

In col 1, the string “patterns” is compared with the first byte of row 1. Namely, the 4-byte string “patt” is compared in row 1 and the string “erns” is compared in row 2. The string in register A is a different one from its first byte, so the result value of comparison is “false.”

In col 2, the string compared in col 1 is shifted down by one byte and then compared as an input value. Namely, the first byte in row 1 is ignored and the subsequent three bytes are compared. The string “tern” is compared in row 2 and the string “s” is compared in row 3, so the result value of comparison is “true” in col 2.

In col 3 and col 4, the string is shifted down by one byte and then compared in the same manner as described above. The comparison values of col 1, col 2, col 3, and col 4 are logic-OR-operated into a match signal by an OR gate 129.

However, this method, which designs a pattern matching device in hardware, has a difficulty in achieving a desired speed, because it is necessary to reprogram the FPGA whenever the number of rules increases, and the complexity of circuits increases for many rules.

### SUMMARY OF THE INVENTION

It is an advantage of the present invention to provide a high-speed pattern storing and matching method that is designed to build a memory lookup of a simple structure for high-speed pattern matching and that can be easily applied to a device in which it is required to add new patterns continuously by making it easier to add or update new rules, and that is applicable to hardware for pattern matching of the IDS (Intrusion Detection System) and fields requiring a high-speed search of a specific pattern.

In one aspect of the present invention, there is provided a high-speed pattern storing method, which is to tabulate and store pattern data constituting rules, the method including: (a) dividing the pattern data into parts having a defined length or less; (b) extracting input position sequence information of each divided part of the pattern data; and (c) assigning a characteristic packet ID to each divided part of the pattern data, and tabulating and storing the divided parts of the pattern data and the input position sequence information of the corresponding parts of the pattern data.

In another aspect of the present invention, there is provided a high-speed pattern matching method, which is to determine whether input data patterns are matched to pattern data tabulated and stored according to a defined rule, the method including: (a) dividing the input pattern data into parts having a defined length or less; (b) searching table information storing the same pattern data as the divided data pattern; (c) extracting table input position sequence information of the corresponding data included in the table information storing the same pattern as the divided parts of the data pattern searched, and table information having the same imput position sequence information of the divided data pattern; and (d) determining from the extracted table information whether the pattern data being constructed is the same as the input data pattern.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a structure for a conventional pattern searching method;

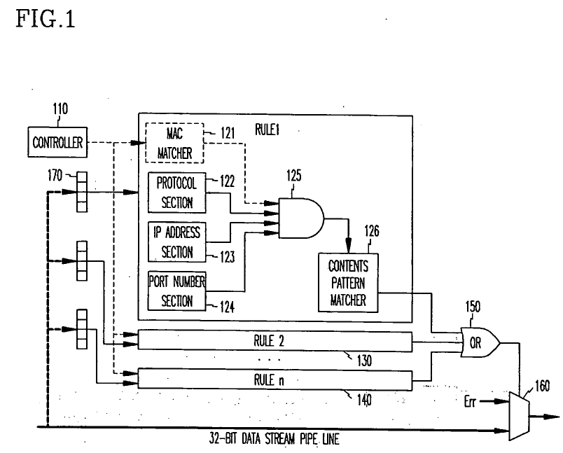

FIG. 2 is a detailed diagram of a structure for the conventional pattern searching method;

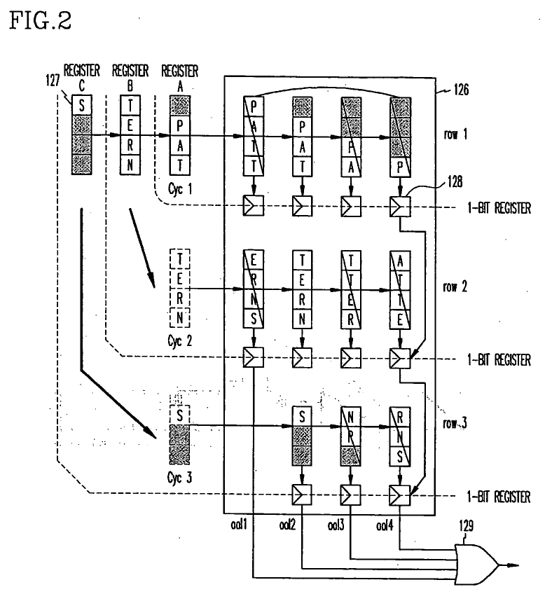

FIG. 3 shows an example of IDS rules and a word dividing method according to an embodiment of the present invention; and

FIG. 4 is a configuration showing a sentence connection in a hash table according to an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

In determining intrusion detection rules according to an embodiment of the present invention, a rule that a sentence constituting intrusion detection rules has the same strings at the same positions appears in many cases.

Hence, the rule-constituting sentence is divided into parts each defined as “word” having a defined length or less, and the individual words are separately looked up in a table and connected together. In this way, the rule can be detected.

In dividing one sentence into words, it is possible to prevent a word repeating at different positions of the sentence by varying the lengths of the words only at positions at which a rule appears stating that there is no word repeating at different positions or that there is such a repeating word. Hence, based on the fact that the individual words have an independent connection based on their sequence information, the number of patterns to be compared according to position is equal to or smaller than the number of rules, and the individual words are separately selected and connected together in a proper sequence to determine the accurate rule.

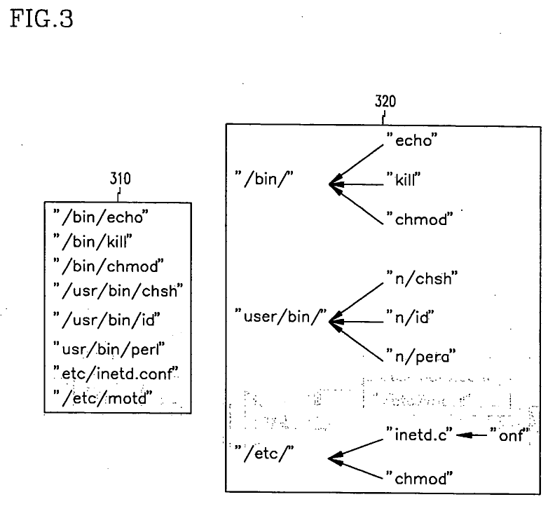

FIG. 3 shows an example of IDS rules and a word dividing method according to an embodiment of the present invention.

Referring to FIG. 3, a description will be given, by way of an example, of eight rules among web-attack rules of snort, which is an open source IDS according to an embodiment of the present invention.

The eight rules are shown in a first block 310 of FIG. 3. To make up a hash table, the repeating sentence among the rules is extracted and divided into words having a length of 7 bytes or less, and the connections of the words are presented in a second block 320.

In searching for “/bin/echo” by a computer using the example of FIG. 3, a search of word “/bin/” is first carried out as follows.

Conventionally, the word “/bin/” is searched and the pointers of three words possibly subsequent to “/bin/” are then detected to compare “echo”, “kill”, and “chomod” with the data, in sequence.

In this method, the time required for data comparison increases with an increase in the amount of data, because after a search of “/bin/”, the next three sentences are compared with input data in sequence and the time required for data comparison increases by the increased amount of data to be compared.

Here, the data storing space can be reduced by storing data according to the data structure of the second block 320 as illustrated in FIG. 3 according to the embodiment of the present invention.

But, a problem occurs in regard to real-time implementation for searching a target pattern from input packets in real time. In accordance with the embodiment of the present invention, the data of the second block of FIG. 3 are stored in multiple hash tables according to the hash value of each word.

In this method, the words divided from the input sentence are separately looked up in the hash table and output with information about the positions at which they are stored.

By using the individual words looked up in the hash table and their position information in the hash table, the sequence of the words can be compared to determine the whole sentence.

Next, the connections of the individual words stored in the hash table will be described as follows.

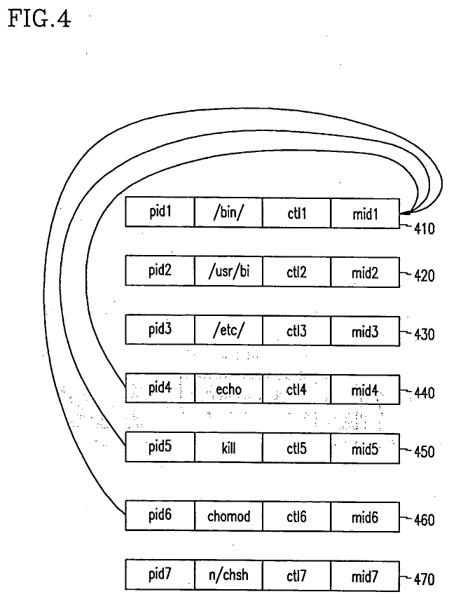

FIG. 4 is a configuration showing a sentence connection in a hash table according to an embodiment of the present invention.

Referring to FIG. 4, each address of the hash table has data about the previous ID “pid” and the ID “mid” of a corresponding word and shows the connections of the words stored in the hash table.

Here, the ID of the corresponding word can be used instead of the memory address storing the ID of the word.

In FIG. 4 according to the embodiment of the present invention, the individual words are stored in multiple hash tables, among which a first table 410 represents the address of the hash table storing “/bin/”.

The first table 410 shows a connection to pid 1 and what word is connected previous to the word corresponding to this address. “/bin/” shown in the first table 410 is the first word constituting the rule and other information for this first word is stored in pid 1.

For example, the word stored in the first, second, and third tables 410, 420, and 430 are the first word of the sentence, so pid 1, pid 2, and pid 3 store the HTTP ID according to the rule using the HTTP protocol rather than information about the previous word in the embodiment of the present invention. Thus the exemplified rules can be determined only in the HTTP protocol. The numeral “1” is assigned to Ctl1, Ctl2, and Ctl3, as information representing that the corresponding word is the first one of the sentence. The numeral “2” is assigned to Ctl4, Ctl5, Ctl6, and Ctl7 of fourth to seventh tables 440 to 470 storing the second word, as a means for checking whether or not each word is detected and compounded at the right position.

For the word “echo”, which is the second and last word, Ctl4 stores information of “2” representing that the corresponding word is the second one of the sentence, and information representing that the word is the last one. So, the searching process ends right after the word having the last word information.

When the input packet uses the HTTP protocol and contains a sentence “/bin/lecho/” in FIG. 4, the words “/bin/” and “echo” are looked up in the first and fourth tables 410 and 440.

If the ID for the HTTP protocol is stored in pid of the first table, then the HTTP protocol is identified from the pid 1 and the head of the packet, and the generated ID is compared. When it is determined that the packet using the HTTP contains “/bin/”, the search of the sentence is continued.

If the input packet does not use the HTTP protocol, then the result of protocol comparison is “false” and the first word “/bin/” is not correctly detected, with a search result of “false.”

The first word “/bin/” is connected to the next one “echo”, since pid 4 of the fourth table 440 storing the word “echo” is connected to mid 1. pid 1 of the first table 410 contains information representing that the corresponding word is the first word of the sentence, and pid 4 of the fourth table 440 contains information representing that the corresponding word is the second and last word. Finally, the sentence is completely detected.

Meta characters, such as mat*.dat- in the sentence can be processed using inter-word space information. When “mat*.dat” is the target sentence, for example, “mat” and “dat” are separately searched out as words and information representing that other words or characters can be interposed between the two words is stored as the space information in the table that stores the words.

The space information is used to process the meta characters in checking the connections of the individual words. The ct1 field of each table is used for this information. The function of processing meta characters is necessary for a pattern search but it is hard to implement it in hardware.

In case of using hash tables for a search of words as in the embodiment of the present invention, multiple small hash tables can be used in detecting different words having a same hash value so as to prevent a conflict of hash keys.

To solve the problem that the method using multiple tables cannot search a desired word correctly, a process of checking whether a corresponding word is matched to the input word of the hash table and whether the corresponding word is at the right position is included to define a unique word.

It requires a lot of power consumption in hardware to read out each table according to the hash value occurring in an input table. So, the number of times to read out the table for comparison of words can be reduced by storing sequence information of words in the sentence in a separate table, reading out the sequence information to determine whether the sequence of words is correct or not, and comparing the words.

If needed, a method of using one common word as a suffix can be implemented. In this method, the part of the sentence excepting the word used as a suffix is assumed to be one sentence and “end” is attached at the end of the sentence with one ID assigned to the corresponding word, so the last words of sentences having the same suffix have the same ID. This makes it easier to process sentences having the same suffix.

The small hash tables have a small number of hash bits, so different words having the same length can have the same hash value in many cases. Hence, there is a need for a function of selecting a hash table using the hash value and directly comparing the input string with the strings stored in the table to determine whether the input string is matched to a desired one.

In consideration of the fact that hardware implementation can be easily achieved when the words stored in the hash table are short, the embodiment of the present invention suggests a method of dividing words to be stored in the hash table into parts having a defined length or less and comparing the divided words.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the high-speed pattern storing and matching method according to the present invention is constructed with a simple memory lookup, is designed to achieve easiness in addition or update of new rules and continuous addition of new patterns for search, and is applicable to fields such as rule-based IDS or fingerprint comparison, or DNS comparison, that require a high-speed search of specific patterns from a large amount of data, thereby implementing high-speed pattern matching.

Based on the fact that the sequence information of the individual words are independently given, the method of the present invention includes looking up words in a table storing word information and comparing one word with the previous one to complete a sentence, thereby achieving a pattern search in real time.

1. A high-speed pattern storing method, which is to tabulate and store pattern data constituting rules, the method comprising:
(a) dividing the pattern data into parts having a defined length or less;
(b) extracting input position sequence information of each divided part of the pattern data; and
(c) assigning a characteristic packet ID to each divided part of the pattern data, and tabulating and storing the divided parts of the pattern data and the input position sequence information of the corresponding parts of the pattern data.

2. The high-speed pattern storing method as claimed in claim 1, wherein the table information includes pattern ID information peculiar to the pattern data having an input position next to the pattern data stored in the corresponding table information.

3. The high-speed pattern storing method as claimed in claim 1, wherein space information of the corresponding pattern data is included to process meta characters.

4. The high-speed pattern storing method as claimed in claim 1, wherein the step (c) includes determining information of a packet head as the characteristic packet ID when the pattern data is the first in the input position sequence among the divided parts of the pattern data.

5. The high-speed pattern storing method as claimed in claim 1, wherein the step (c) includes storing, in a separate table, and multiplexing the pattern data stored in the corresponding table, the input position sequence of the corresponding pattern data, or the pattern data subsequent to and different from the corresponding pattern data.

6. The high-speed pattern storing method as claimed in claim 1, wherein pattern data having the same divided part of the last sequence are stored to make the divided part of the pattern data of the last sequence have the same position information.

7. The high-speed pattern storing method as claimed in claim 1, wherein in the step (c), information representing that the corresponding pattern data is the pattern data of the last sequence is included in the input position sequence information when the divided part of the pattern data is at the last position.

8. The high-speed pattern storing method as claimed in claim 1, wherein the pattern data are stored in a hash table, and a hash value of each divided part of the pattern data, sequence information of the corresponding divided part of the pattern data and word connection information are stored.

9. A high-speed pattern matching method, which is to determine whether input data pattern are matched to pattern data tabulated and stored according to a defined rule, the method comprising:
(a) dividing the input pattern data into parts having a defined length or less;
(b) searching table information storing the same pattern data as the divided data pattern;
(c) extracting table input position sequence information of the corresponding data included in the table information storing the same pattern as the divided parts of the data pattern searched, and table information having the same input position sequence information of the divided data pattern; and
(d) determining from the extracted table information whether the pattern data being constructed is the same as the input data pattern.

10. The high-speed pattern matching method as claimed in claim 9, wherein the stored pattern data includes:
a packet ID representing an input position sequence of the corresponding pattern data; and
packet ID information of pattern data subsequent to the input position of the corresponding pattern data.

11. The high-speed pattern matching method as claimed in claim 9, wherein the step (b) includes stopping a search for pattern data connected to the corresponding pattern data when the input position information of the divided parts of the pattern data is different from the input position information of pattern data being the same as the corresponding data pattern.
